(19) United States
(12) Patent Application Publication
(10) Pub. No.: US 2021/0259456 A1
(43) Pub. Date: Aug. 26, 2021

(54) Particulate Collection Device

(71) Applicant: GERARD LYNCH, MIDDLESEX, NJ (US)

(72) Inventor: GERARD LYNCH, MIDDLESEX, NJ (US)

(21) Appl. No.: 16/795,848

(22) Filed: Feb. 20, 2020

(51) Int. Cl. A47J 31/06

(52) U.S. Cl. CPC A47J 31/0689

(57) ABSTRACT

A particulate collection device 10 designed to fit commercial reusable coffee pods and/or capsules 12, which include: a coffee grind collection housing 20 having at least one sidewall 21 forming an enclosure for communicating with drainage apertures 22 at the bottom thereof, and a coffee grind collection housing lid 14 having a reusable coffee pod filter receptacle 16 and a water drainage channel 18.

### FIELD OF THE INVENTION

The present invention is for the disposal of spent coffee grounds left in the prior art devices. When hot coffee grounds are left inside the prior devices, they are hard and messy to empty and clean. The present device allows for easy removal of the hot coffee grounds from the prior art devices.

### BACKGROUND OF THE INVENTION

The present invention relates to a collection device and, more particularly, to a device for the cleaning of and collecting particulates from reusable filters for brewing systems that use pre-filled filter packs.

Today, the use of coffee brewing systems that use pre-filled reusable filters is widespread. Such systems include, but are not limited to Keurig® K-Cup brewing systems. Because such systems do not have a collection process for the heated and moisture-laden particulate contents, a user of such system must tap and/or rinse the particulate contents from the reusable filters, usually over a sink or garbage. Such a disposal process necessitates handling the heated and messy contents that may clog the sink. Consequently, many users of such systems choose to use pre-filled disposable filter pack K-Cups and filter packs. A device that can clean K-Cup and filter packs in a convenient, less wasteful, time saving manner.

### DESCRIPTION OF THE PRIOR ART

K-Cup has disclosed a cleaning and descaling kit for the K-Cup brewer in a Keurig machine, which removes the non-toxic stains and limescale from the heating element to ensure proper brewing temperature. The cleaning cup ensures that the oily residue is removed from the exit spout, which can cause bitter tasting coffee.

### OBJECTS OF THE INVENTION

It is an object of the present invention to provide a collection device for the disposal of spent coffee grounds.

It is another object of the present invention to provide a collection device which allows for easy removal of the spent hot coffee grounds.

It is another object of the present invention to provide a device for the cleaning and collecting of particulates from reusable filters.

### SUMMARY OF THE INVENTION

A particulate collection device 10 designed to fit commercial reusable coffee pods and/or capsules 12, which include: a coffee grind collection housing 20 having at least one sidewall 21 forming an enclosure for communicating with drainage apertures 22 at the bottom thereof, and a coffee grind collection housing lid 14 having a reusable coffee pod filter receptacle 16 and a water drainage channel 18.

### BRIEF DESCRIPTION OF THE DRAWINGS

FIG. 1 is a perspective view of the assembled particulate collection device;

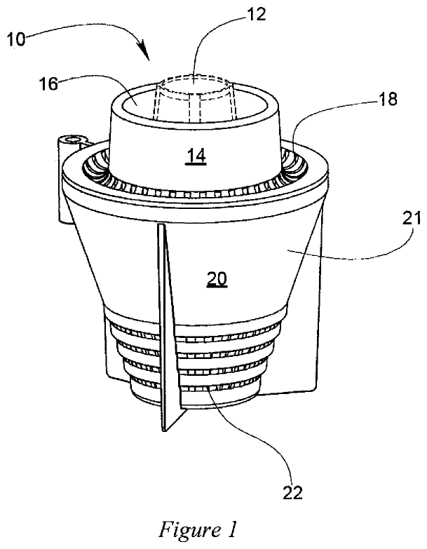

FIG. 2 is an exploded view of the unassembled parts shown in FIG. 1; and

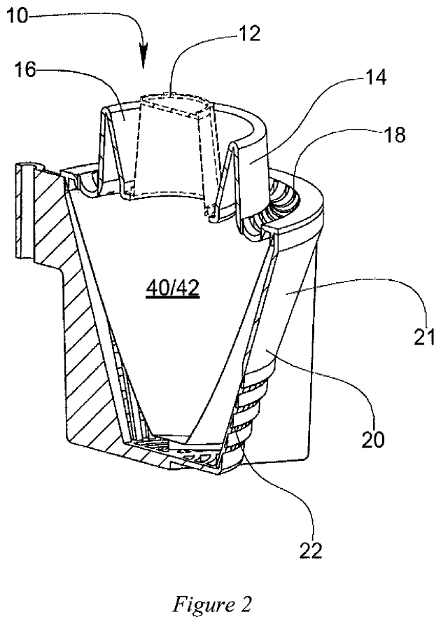

FIG. 3 is a cut away interior section of the assembled particulate collection device.

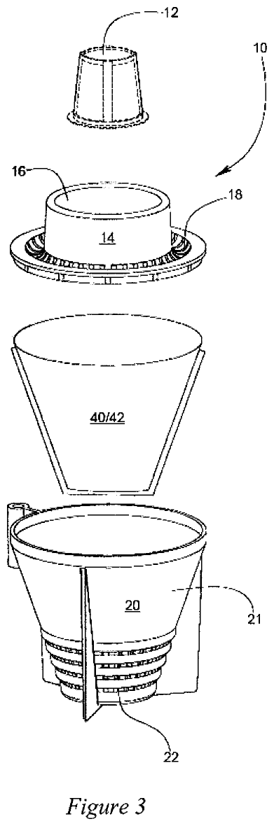

### DETAILED DESCRIPTION

A particulate collection device 10, designed to fit commercial reusable coffee pods and/or capsules 12 includes: a coffee grind collection housing 20 with at least one sidewall 21 forming an enclosure for communicating with fluid openings 22 at the bottom thereof, and a coffee grind collection housing lid 14 consisting of a reusable coffee pod filter receptacle 16 and a water drainage channel 18. The coffee grind collection housing lid 14 is stationary and does not rotate, and does not have a fluid injector. The coffee grind collection housing 20 is adapted to receive an environmentally disposable filter paper 40 or a cleanable filter 42 to retain the coffee grinds for consolidated waste disposal. The filter 40/42 is in fluid communication with the coffee grind collection housing 20. The reusable coffee pods and/or capsules 12 sit firmly inside the filter receptacle 16. The reusable coffee pods and/or capsules 12 can be emptied by tapping the top of the inverted reusable coffee pods and capsules and/or by rinsing them with tap water thus depositing the grind contents into the disposable paper filter 40/42. In this manner, spilled grinds will fall through the water drainage channel 18. Excess water flows through the paper filter 40/42 and out of the coffee grind collection housing 20 by means of the fluid openings 22 at the bottom thereof. The plurality of fluid apertures 22 are oriented along an angle defined by an upper portion of the chamber wall 21.

The particulate collection device 10 is designed to fit commercial “K-Cup” reusable filter screens 12, and includes a particulate filter-collector having at least one sidewall 21 forming an enclosure communicating with a fluid opening. The filter receptacle and cover 14 are stationary and do not rotate, and do not have a fluid injector. A plurality of drainage apertures 22 are formed along the sidewall 21. A disposable filter is housed within the enclosure 40/42, wherein the fluid opening and the lid 14 have peripheries that are dimensioned and adapted to form a removable sealing engagement.

### ADVANTAGES OF THE PRESENT INVENTION

It is an advantage of the present invention is to provide a collection device for the disposal of spent coffee grounds.

It is another advantage of the present invention to provide a collection device which allows for easy removal of the spent hot coffee grounds.

It is another advantage of the present invention to provide a device for the cleaning and collecting of particulates from reusable filters.

A latitude of modification, change and substitution is intended in the foregoing disclosure, and in some instances, some features of the invention will be employed without a corresponding use of other features. Accordingly, it is appropriate that the appended claims be construed broadly and in a manner consistent with the spirit and scope of the invention herein.

What is claimed is:

1) A particulate collection device (10) designed to fit commercial reusable coffee pods (12) and capsules, comprising:
a) a coffee grind collection housing (20) having an inner rinse chamber (18) and a particulate filter-collector in the form of a filter receptacle (16) and a cover (14); said rinse chamber (18) having at least one chamber side wall (21) forming an enclosure (23) communicating with a plurality of drainage apertures (22) at the bottom thereof, wherein said filter receptacle (16) and cover (14) are stationary and do not rotate, and do not have a fluid injector;
b) said plurality of drainage apertures (22) formed along said sidewall (21);
c) said filter receptacle (16) and cover (14) cooperates with said coffee grind collection housing (20) and said chamber side wall (21), which is centrally disposed, wherein a disposable filter (40/42) is in fluid communication with said housing (20), wherein said drainage apertures (22) and said filter (16) form a removable sealing engagement;
d) said coffee grind collection housing (20) is adapted to receive an environmentally disposable filter paper (40) or a cleanable filter (42) to retain the coffee grinds for consolidated waste disposal; and
e) wherein reusable coffee pods (12) and capsules sit firmly inside said filter receptacle (16) and said cover (14), so that said rinse chamber (18) may be cleaned by tapping the top of the inverted reusable coffee pods and capsules and/or by rinsing them with tap water.

2) The particulate collection device of claim 1, wherein said chamber side wall (21) forms said rinse chamber (18) in fluid communication with said enclosure (15).

3) The particulate collection device of claim 1, wherein said plurality of fluid drainage apertures (22) are formed in the filter seat so as to circumscribe said chamber wall.

4) The particulate collection device of claim 1, wherein said plurality of fluid drainage apertures (22) are oriented approximately normal to a bottom portion of said chamber side wall (21).

5) The particulate collection device of claim 4, wherein said plurality of fluid drainage apertures (22) are oriented along an angle defined by an upper portion of said chamber side wall (21) and the periphery of said filter seat.

6) The particulate collection device of claim 1, further including a disposable filter housed within said enclosure (15).

7) The particulate collection device of claim 1, wherein said plurality of drainage apertures (22) are dimensioned so as to filter particulates.

8) The particulate collection device of claim 1 is designed to fit commercial reusable “K-Cups.”

9) The particulate collection device of claim 1 is designed to fit commercial “K-Cup” reusable filter screens, including a particulate filter-collector having at least one sidewall forming an enclosure communicating with a fluid opening.
